(19) United States
(12) Patent Application Publication
(10) Pub. No.: US 2007/0118657 A1
(43) Pub. Date: May 24, 2007

(54) Method and system for sharing podcast information

(75) Inventors: Stuart S. Kreitzer, Coral Springs, FL (US); Joseph L. Dvorak, Boca Raton, FL (US); Charles D. Estes, Fort Lauderdale, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/284,750

(22) Filed: Nov. 22, 2005

(51) Int. Cl. G06F 15/16

(52) U.S. Cl. 709/227

(57) ABSTRACT

A method (200) and system (100) for sharing podcast information includes a wireless communication device (101) having a transceiver (102), and a processor (104) coupled to the transceiver. The processor can be programmed to play (202) a podcast having associated metadata on a wireless communication device and transfer (204) a hyperlink and the associated metadata to a remote device (103) while playing the podcast on the communication device. The processor can be further programmed to transfer the hyperlink and the associated metadata to the remote device while playing the podcast by using a push-to-transmit function (109) on the communication device. The remote device receives the link and associated metadata and decodes (206) the associated metadata. The associated metadata can include constructs having start times and end times for the podcast, bookmarks for portions of the podcast, digital rights management information, display description, podcast category, or relevant images.

### FIELD

This invention relates generally to podcasts, and more particularly to a method and system for sharing podcast information while playing a podcast presentation.

### BACKGROUND

Podcasting is a known method of publishing audio and video programs via the Internet, allowing users to subscribe to a feed of files that usually come in MP3 format. Although “Podcasting” in its strictest sense is distinct from other types of online media delivery because of its subscription model, which uses a feed to deliver an enclosed file, the word “Podcast” is frequently used to describe the posting of any link to a media-player-compatible audio file on a website. Some radio personalities post MP3 versions of their shows daily, and even though these are simple download links and not part of any subscription model, they are nonetheless typically referred to as “Podcasts.” Listeners may subscribe to feeds using “podcatching” software, which periodically checks for and downloads new content automatically. Most podcatching software enables the user to copy podcasts to portable music players. Any digital audio player or computer with audio-playing software can play podcasts.

Many cellular phones now include MP3 functionality and enable the listening of Podcasts. Sharing information about a particular podcast with a friend or colleague today involves calling or emailing your friend or colleague, probably after writing down the universal/ uniform resource locators of the podcast.

### SUMMARY

Embodiments in accordance with the present invention can provide a data construct and a way to easily share great podcasts (or easy access thereto) with their friends and colleagues. If a listener enjoys a particular podcast on a mobile phone and would like to share or refer the podcast to another user perhaps because it is very entertaining or contains information that would be of interest to the other party, then embodiments herein enable such access to other users along with the ability to annotate or comment on such podcasts and transmit such annotation or commentary with others.

In a first embodiment of the present invention, a method of sharing podcast information can include the steps of playing a podcast having associated metadata on a wireless communication device and transferring a link or hyperlink and the associated metadata to a remote device while playing the podcast on the wireless communication device. A hyperlink is known as a link from a hypertext file to another location or file which is typically activated by clicking on a highlighted word or icon at a particular location on a screen. Of course, a link or hyperlink as used interchangeably here should not be limited to the traditional definition of hyperlink, but should include other reasonably equivalent links that can generally enable the download of podcasts. The method can further include receiving the link and associated metadata and decoding the associated metadata at the remote device. Decoding can involve decoding constructs including at least a Universal/ Uniform Resource Locator (URL) or similar address for downloading the podcast, or constructs having start times for the podcast, end times for the podcast, bookmarks for portions of the podcast, digital rights management information, display description, podcast category, or relevant images. The associated metadata can include URLs for mobile blogging, a sender's weblog, a video blog, a social contact site, contact information from a sender, or a vCard record. The method can further include the step of coupling the remote device to a high bandwidth channel for downloading the podcast. The coupling can involve placing the remote device in a cradle and downloading the podcast over a secondary network serving as the high bandwidth channel. Of course, the remote device itself can be a high-bandwidth wireless device and also receive the link and download the podcast directly (without having to couple to a cradle or secondary network) since podcatcher software can be built into the remote device and the remote device itself can have a high-bandwidth connection such as a 3G or 4G network. In such an instance, there is no need for a secondary network or cradle

The method can further include the step of creating a hierarchy of metadata at the wireless communication device enabling a sender to mark a URL associated with the podcast, mark a starting point for a portion of the podcast, or mark an ending point for the podcast. The method can further include the step of creating a hierarchy of metadata at the wireless communication device enabling a sender to attach additional metadata to the associated metadata including links to other websites, links to a sender's weblog, mobile weblog, or video blog, or a sender's contact information.

In a second embodiment of the present invention, a wireless communication device can include a transceiver, a storage medium for downloading and playing a podcast, and a processor coupled to the transceiver. The processor can be programmed to play a podcast having associated metadata on a wireless communication device and transfer a link and the associated metadata to a remote device while playing the podcast on the. wireless communication device. The processor can be programmed to transfer the link and the associated metadata to the remote device while playing the podcast by using a push-to-transmit function on the wireless communication device. The wireless communication device can further include a user interface to create a hierarchy of metadata at the wireless communication device enabling a sender to mark a URL associated with the podcast, mark a starting point for a portion of the podcast, or mark an ending point for the podcast. The wireless communication device can further include a user interface for creating a hierarchy of metadata enabling a sender to attach additional metadata to the associated metadata including links to other websites, links to a sender's weblog, mobile weblog, or video blog, or a sender's contact information or a vCard record, or a similar contact record.

In a third embodiment of the present invention, a system for sharing podcast information can include a wireless communication device having a transceiver, and a processor coupled to the transceiver. The processor can be programmed to play a podcast having associated metadata on a wireless communication device and transfer a link and the associated metadata to a remote device while playing the podcast on the wireless communication device. The processor can be further programmed to transfer the link and the associated metadata to the remote device while playing the podcast by using a push-to-transmit function on the wireless communication device. The system can further include remote device that receives the link and the associated metadata. The remote device can be programmed to receive the link and associated metadata and decode the associated metadata. The associated metadata can include constructs having start times for the podcast, end times for the podcast, bookmarks for portions of the podcast, digital rights management information, display description, podcast category, or relevant images.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a system for sharing podcast information in accordance with an embodiment of the present invention.

FIG. 2 is a flow chart illustrating a method of sharing podcast information in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

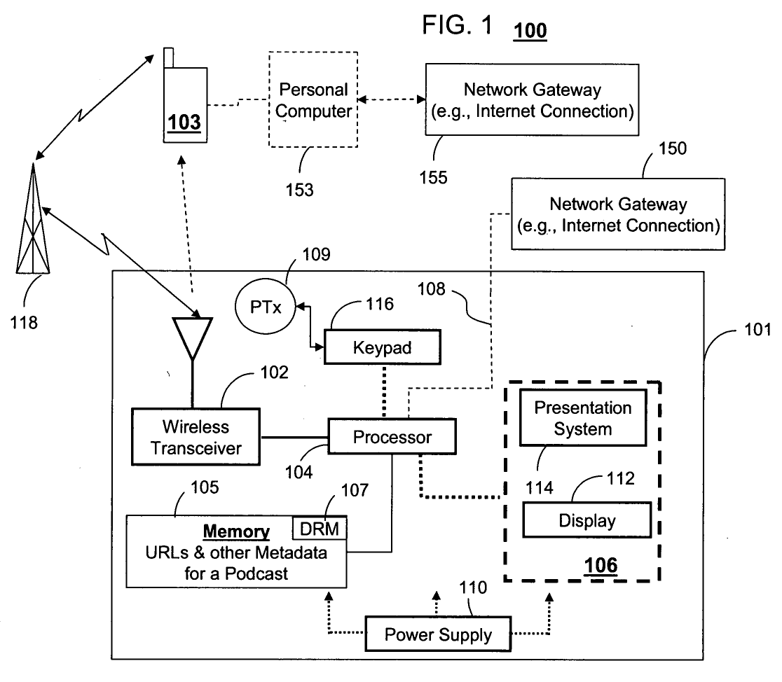

Referring to FIG. 1, a block diagram of a wireless communication system 100 is shown for sharing podcast information in accordance with an embodiment herein. The podcast information can be carried in a mobile device or a wireless communication device 101 such as a selective call receiver or transceiver that can include a transceiver 102 and a processor 104 coupled to the transceiver 102. The processor 104 can be programmed to receive podcast information and other information and/or content over a wireless network or a wired network via a local access point 150 device network gateway for example. Note, the transceiver 102 can be a part of a cellular phone, a satellite phone, a smart phone, a laptop computer, a personal digital assistant, or a two-way messaging device or other communication device and the local access point 150 can be any type of connection to podcast content such as an Internet connection.

The wireless communication device 101 can further include a user interface 106 having a presentation system 114 (such as audio speakers and amplifiers) and a display 112. The wireless communication device 101 can further include a keypad 116, a memory 105 for storing URLs, metadata, podcast content (etc.), and a power supply 110. The device 101 can further include a digital rights management module 107 which can be part of the memory 105. The wireless communication device 101 can further optionally or alternatively include a data bus, link, or interface 108 for coupling the processor 104 with the gateway 150 in a wired or tethered fashion as opposed to a wireless link. The wireless transceiver 102 can utilize existing technology for exchanging wireless messages with a base station 118 over a link or network to communicate to another wireless device 103 that the user of device 101 wishes to share podcast information with. Once the wireless device 101 transmits a podcast link or URL and other metadata to the wireless device 103, the wireless device 103 can retrieve the podcast content from an appropriate network gateway 155 such as an internet connection via their personal computer 153 for example. The wireless device may also be able to retrieve podcast content using its own high-speed wireless data connection, if available, as an alternative to connecting to the internet via a personal computer 153. Of course, the device 101 can also communicate directly to device 103 if applicable wireless technologies are utilized (Bluetooth, WiFi, Talkaround, etc.). The wireless technology used can be any wireless technology such as, for example, GSM (Global System for Mobile communication), TDMA (Time Division Multiple Access), or CDMA (Code Division Multiple Access), just to mention a few.

The processor 104 can use computing and/or processing such as a microprocessor and/or a DSP (Digital Signal Processor) technology. Additionally, the processor 104 can include media such as RAM (Random Access Memory), DRAM (Dynamic RAM), ROM (Read Only Memory), and/or Flash memory for data processing and storage. The presentation system 114 can use audio technology for intercepting and conveying audible signals to or from a user of the wireless communication device 101. The display 112 can also utilize technology such as an LCD (Liquid Crystal Display) for conveying images to the user with an optional backlight. The keypad 116 can be an input device coupled to the processor 104 for intercepting tactile responses from the user and can also include its own backlight. These responses can be, for instance, tactile responses that represent telephone number dialing for accessing another end user or passwords or account numbers enabling the retrieval of licensed content. Generally speaking, the keypad 116 serves to control operations of the wireless communication device

The power supply 110 utilizes energy conversion technology for supply energy to the aforementioned components of the wireless communication device 101. The power supply 110 can be, for instance, a portable battery-operated supply for portable applications of the wireless communication device 101.

Embodiments herein can utilize push-to-talk (PTT) or push-to-connect (PTx) (109) or messaging technologies to forward a podcast link while listening to the podcast. Furthermore, links to segments of a podcast rather than the whole can be forwarded. Also, metadata can be added to the link to convey additional information along with the podcast link.

As previously mentioned, podcasting is a fast growing medium that allows almost anyone with a personal computer to produce radio or video shows that are posted for download over the internet. There are over 5000 podcasts currently available including many amateur podcasts as well as professional shows from sources such as the BBC and National Public Radio. A typical podcast listening setup includes podcatcher software installed on a listeners personal computer which allows users to subscribe to podcasts and automatically download new shows when they are made available. Downloaded shows can be transferred to portable MP3 players including dedicated devices such as the iPOD or MP3-equipped mobile phones for listening on-the-go.

While the iPod is the namesake for podcasting, mobile phones such as iDEN phones by Motorola, Inc. offer the potential for new capabilities that go beyond what today's MP3 players can do. Although other transmission technologies can by used, certain embodiments herein can leverage PTT technology to share podcasts with friends or colleagues in an easy fashion.

Currently, podcast listeners must sort through the thousands of available podcasts using web-based directories such as PodcastAlley.com or a podcatcher with built-in directories such as iTunes or iPodder. While these directories offer search capabilities and sorting-by-subject, it's still a chore to find the shows that best suit one's interests. And, the task is made more daunting because you have to subscribe, download, and listen to shows before you can make a judgment about whether a given show is “a keeper”.

Embodiments herein enable a way to share great podcasts that users have found with their friends and colleagues while they are listening to a podcast on their mobile phone. A user can refer the podcast (or a link thereto) to another user perhaps because it is very entertaining or contains information that would be of interest to the other party.

While listening to the podcast, a user can press the PTT button 109 on the phone and select a contact from their contact list as a target. Rather than send the entire podcast, which could be quite large (30-50MB is common), the phone can send a URL link and a description of the podcast to the other party. Upon receiving the link, the other party can opt to accept or reject the recommendation. If accepted, the recipient's phone can enter the URL into a podcast subscription queue in the handset. At a later point in time, perhaps at the end of the day, the recipient (103) can likely synchronize their phone with their personal computer podcast client application (residing on their personal computer 153), sometimes called a podcatcher, to get the latest podcasts. In addition to the usual process of downloading podcasts to the phone, the podcatcher software can take the additional step of querying the podcast subscription list in the phone and can discover that the user had accepted a subscription to a new podcast. This can trigger the podcatcher to subscribe and download the new podcast. As previously noted, some wireless devices will have a high-bandwidth connection (3G, 4G) and podcatcher software built-in which can eliminate the need to synchronize with a personal computer. In such an instance, the user of the remote device can receive the link and subscribe immediately rather than having to wait to synchronize with a personal computer.

Note, the podcast link is sent while listening to the podcast rather than as a simple email attachment that is sent at sometime other than while listening. This real time transfer allows for a greater degree of collaboration between the two users and offers the potential for new services.

Although the process of sending a link to a podcast is described so that an entire podcast can be subscribed and downloaded, other embodiments herein can send a link to a subset of a podcast. As an example, suppose an interview that was part of a longer podcast found to be interesting to the sender and likely to the recipient is all the sender wants to send to the recipient rather than the entire podcast, then the sender can add a start and stop time to the link. In other words, just a subset of a podcast can be specified. A possible usage example can enable a user listening to a podcast to bookmark a start and stop point in the podcast and forward the link to another party. As before, the party can accept the link and once they synchronize with their podcatcher client, the podcast will be downloaded and truncated so that just the specified part of the podcast is transferred to the user's phone.

Below, are examples of URLs for standard and bookmarked podcasts: http://www.host.com/podcast.xml ;standard podcast http://www.host.com/podcast.xml, start=hhmmss, stop=hhmmss ;with bookmarks

The bookmarks are versatile and can be used to quote just a section somewhere in the middle of the podcast. The bookmarks can also be used with only a start or only an end point in order to specify a section of a podcast that goes from the beginning to some intermediate point or from an intermediate point to the end of the podcast.

Another aspect allows a podcast audio file to be accompanied by a sidecar file containing bookmarks that mark sections of the podcast. In this case, links that are sent via PTT to other users can contain start=#bookmark and stop=#bookmark statements that would symbolically specify start and stop points. For example: http://www.host.com/podcast.xml, start=#bookmark1, stop=#bookmark2

The sidecar files might be a list of bookmark names along with a time index for each bookmark. This file can be implemented in XML or any other suitable format. Furthermore, the bookmarks can be accompanied by URLs that link websites to the time-related bookmarks. This can be used by the recipient phone to access the website when a bookmark is passed during playing of a podcast. The sidecar files can also contain other objects such as images, text, or multimedia that is played in association with the podcast.

Yet another aspect is that additional metadata can be appended to the podcast links. This appended metadata can include links to other websites or data that is sent along with the podcast link. This is useful, for example, if the sender wants the podcast link to be accompanied by a link to the senders Blog (weblog), moblog (mobile weblog), vlog (video blog), social contact site, or contact info from the sender such as a vcard record. The metadata can also include a note to the recipient perhaps explaining the reason for forwarding the podcast link. Here are examples of how the metadata could be sent: http://www.host.com/podcast.xml, metadata=“www.blog.com/myBlog” http://www.host.com/podcast.xml, metadata=“Check out this great podcast . . . Jenna”

Furthermore, the metadata can also include a user rating of the podcast, or text, audio or video commentary to accompany the podcast link (obviously, audio or video metadata would occupy considerably more bandwidth, but is feasible in a high-speed link). The target address to whom the podcast link is being sent could be one of the following:
1. UFMI, IP address or any other PTT addressing method.
2. SMS, MMS, or similar multimedia messaging address.
3. The target address could also include a return address (the senders address), so that the recipient can respond back with a comment, rating, or just a word of thanks.

The carrier medium for the podcast links can include any of the following:
1. Push-to-Talk (PTT) service based on iDEN, VolP, or any other PTT technology.
2. email, MMS, or any other messaging technology provided that the link is formed and sent while listening to the podcast.

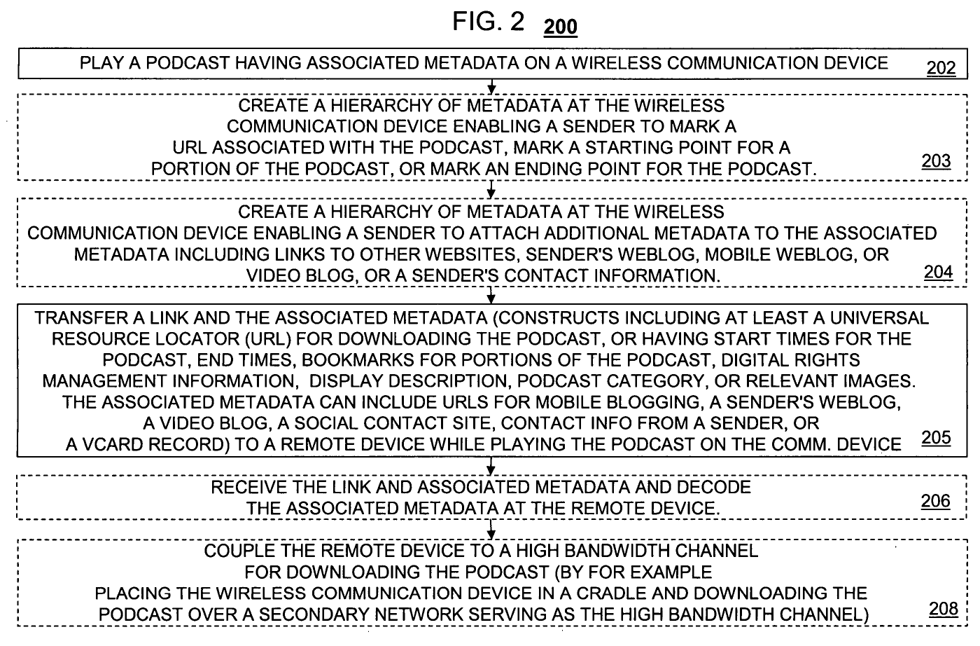

Referring to FIG. 2, a flow chart illustrating a method 200 of sharing podcast information including the step 202 of playing a podcast having associated metadata on a wireless communication device and transferring a link and the associated metadata to a remote device while playing the podcast on the wireless communication device at step 205. The method 200 can further optionally include the step 203 of creating a hierarchy of metadata at the wireless communication device enabling a sender to mark a URL associated with the podcast, mark a starting point for a portion of the podcast, or mark an ending point for the podcast. The method 200 can further include the step 204 of creating a hierarchy of metadata at the wireless communication device enabling a sender to attach additional metadata to the associated metadata including links to other websites, links to a sender's weblog, mobile weblog, or video blog, or a sender's contact information.

The method 200 can further include the step 206 of receiving the link and associated metadata and decoding the associated metadata at the remote device. Decoding can involve decoding constructs including at least a Universal Resource Locator (URL) for downloading the podcast, or constructs having start times for the podcast, end times for the podcast, bookmarks for portions of the podcast, digital rights management information, display description, podcast category, or relevant images. The associated metadata can include URLs for mobile blogging, a sender's weblog, a video blog, a social contact site, contact information from a sender, or a vCard record. The method 200 can further include the step 208 of coupling the remote device to a high bandwidth channel for downloading the podcast. The coupling can involve placing the wireless communication device in a cradle and downloading the podcast over a secondary network serving as the high bandwidth channel.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of sharing podcast information, comprising the steps of:
playing a podcast having associated metadata on a wireless communication device; and
transferring a hyperlink and the associated metadata to a remote device while playing the podcast on the wireless communication device.

2. The method of claim 1, wherein the method further comprises receiving the hyperlink and associated metadata and decoding the associated metadata at the remote device.

3. The method of claim 2, wherein the step of decoding the associated metadata comprises decoding constructs including at least a Universal Resource Locator or similar address for downloading the podcast.

4. The method of claim 3, wherein the step of decoding further comprises decoding the associated metadata for constructs having start times for the podcast, end times for the podcast, bookmarks for portions of the podcast, digital rights management information, display description, podcast category, or relevant images.

5. The method of claim 3, wherein the associated metadata comprises Universal Resource Locators for mobile blogging, a sender's weblog, a video blog, a social contact site, contact information from a sender, or a vCard record.

6. The method of claim 1, wherein the method further comprises the step of coupling the remote device to a high bandwidth channel for downloading the podcast.

7. The method of claim 6, wherein the method further comprises the step of placing the remote device in a cradle and downloading the podcast over a secondary network serving as the high bandwidth channel or the step of using the remote device itself to download the podcast over a high-bandwidth channel used directly by the remote device.

8. The method of claim 1, wherein the method further comprises the step of creating a hierarchy of metadata at the wireless communication device enabling a sender to mark a Universal Resource Locator associated with the podcast, mark a starting point for a portion of the podcast, or mark an ending point for the podcast.

9. The method of claim 1, wherein the method further comprises the step of creating a hierarchy of metadata at the wireless communication device enabling a sender to attach additional metadata to the associated metadata including links to other websites, links to a sender's weblog, mobile weblog, or video blog, or a sender's contact information.

10. Awireless communication device, comprising:
a transceiver;
a storage medium for downloading and playing a podcast; and
a processor coupled to the transceiver, wherein the processor is programmed to:
play a podcast having associated metadata on a wireless communication device; and
transfer a hyperlink and the associated metadata to a remote device while playing the podcast on the wireless communication device.

11. The wireless communication device of claim 10, wherein the metadata comprises at least a Universal Resource Locator for downloading the podcast.

12. The wireless communication device of claim 10, wherein the associated metadata further comprises start times for the podcast, end times for the podcast, bookmarks for portions of the podcast, digital rights management information, display description, podcast category, or relevant images.

13. The wireless communication device of claim 10, wherein the associated metadata comprises Universal Resource Locators for mobile blogging, a sender's weblog, a video blog, a social contact site, contact information from a sender, or a vCard record or a similar contact record.

14. The wireless communication device of claim 10, wherein the processor is programmed to transfer the link and the associated metadata to the remote device while playing the podcast by using a push-to-transmit function on the wireless communication device.

15. The wireless communication device of claim 10, wherein the wireless communication device further comprises a user interface to create a hierarchy of metadata at the wireless communication device enabling a sender to mark a Universal Resource Locator associated with the podcast, mark a starting point for a portion of the podcast, or mark an ending point for the podcast.

16. The wireless communication device of claim 10, wherein the wireless communication device further comprises a user interface for creating a hierarchy of metadata enabling a sender to attach additional metadata to the associated metadata including links to other websites, links to a sender's weblog, mobile weblog, or video blog, or a sender's contact information.

17. A system for sharing podcast information, comprising:
a wireless communication device having a transceiver;
a processor coupled to the transceiver, wherein the processor is programmed to:
play a podcast having associated metadata on a wireless communication device; and
transfer a hyperlink and the associated metadata to a remote device while playing the podcast on the wireless communication device; and
a remote device that receives the link and the associated metadata.

18. The system of claim 17, wherein remote device is programmed to receive the hyperlink and associated metadata and decode the associated metadata.

19. The system of claim 17, wherein the associated metadata comprises constructs having start times for the podcast, end times for the podcast, bookmarks for portions of the podcast, digital rights management information, display description, podcast category, or relevant images.

20. The system of claim 17, wherein the processor is further programmed to transfer the hyperlink and the associated metadata to the remote device while playing the podcast by using a push-to-transmit function on the wireless communication device.
